(19) United States
(12) Patent Application Publication
(10) Pub. No.: US 2026/0289654 A1
(43) Pub. Date: Sep. 24, 2026

(54) Electronic Devices and Corresponding Methods for Generating Personalized Item Content for a Content Renderer

(71) Applicant: Motorola Mobility LLC, Chicago, IL (US)

(72) Inventors: Amit Kumar Agrawal, Bangalore (IN); Nakul Patel, Bangalore (IN); Krishnan Raghavan, Bangalore (IN)

(21) Appl. No.: 19/084,243

(22) Filed: Mar. 19, 2025

(51) Int. Cl. G06Q 30/0601; G06F 16/951; G06T 19/00; H04N 21/254

(52) U.S. Cl. CPC G06Q 30/0643; G06F 16/951; G06T 19/006; H04N 21/2542

(57) ABSTRACT

A method in an electronic device includes, in response to initiation of an interactive session in an electronic shopping interactive computing environment, detecting, by a user interface operable with the one or more processors, user input from a user selecting an item having a display to be rendered to the user by a content renderer. The method includes retrieving, from a personal knowledge data store associated with the user, personalized visual content suitable for presentation by the item on the display, generating, by the one or more processors, personalized item content for the content renderer by causing digital renderings of the personalized visual content to be presented on the display in renderings of the item, and transmitting, by the one or more processors using a communication device, the personalized item content to the content renderer.

### BACKGROUND

### Technical Field

This disclosure relates generally to electronic devices, and more particularly to electronic devices having augmented reality feature sets.

### Background Art

In the rapidly evolving landscape of e-commerce, immersive technologies have emerged as transformative tools, enabling users to visualize products within their physical spaces. This experience allows consumers to see how items such as furniture and decor will fit in their homes, enhancing the shopping experience by reducing uncertainty and increasing engagement. However, current implementations often lack personalization, presenting products in a generic manner without considering individual user preferences or needs. This limitation results in a missed opportunity to create a more engaging and tailored shopping experience that could significantly boost consumer confidence and satisfaction. It would be advantageous to have improved electronic devices and corresponding methods that offer a more engaging and relevant user interaction experience.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present disclosure.

FIG. 1 illustrates one explanatory electronic device in accordance with one or more embodiments of the disclosure.

FIG. 2 illustrates another explanatory electronic device in accordance with one or more embodiments of the disclosure.

FIG. 3 illustrates one or more method steps in accordance with one or more embodiments of the disclosure.

FIG. 4 illustrates one explanatory system in accordance with one or more embodiments of the disclosure.

FIG. 5 illustrates one explanatory method in accordance with one or more embodiments of the disclosure.

FIG. 6 illustrates one or more method steps in accordance with one or more embodiments of the disclosure.

FIG. 7 illustrates one or more method steps in accordance with one or more embodiments of the disclosure.

FIG. 8 illustrates various embodiments of the disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Before describing in detail embodiments that are in accordance with the present disclosure, it should be observed that the embodiments reside primarily in combinations of method steps and apparatus components related to, in response to initiation of an interactive session in an electronic shopping interactive computing environment operating on one or more processors of the electronic device, detecting, by a user interface operable with the one or more processors, user input from a user selecting an item having a display to be rendered to the user by a content renderer, retrieving, from a personal knowledge data store associated with the user, personalized visual content suitable for presentation by the item on the display, generating, by the one or more processors, personalized item content for the content renderer by causing digital renderings of the personalized visual content to be presented on the display in renderings of the item, and transmitting, by the one or more processors using a communication device, the personalized item content to the content renderer. Any process descriptions or blocks in flow charts should be understood as representing modules, segments, or portions of code which include one or more executable instructions for implementing specific logical functions or steps in the process.

Alternate implementations are included, and it will be clear that functions may be executed out of order from that shown or discussed, including substantially concurrently or in reverse order, depending on the functionality involved. Accordingly, the apparatus components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

Embodiments of the disclosure do not recite the implementation of any commonplace business method aimed at processing business information, nor do they apply a known business process to the particular technological environment of the Internet. Moreover, embodiments of the disclosure do not create or alter contractual relations using generic computer functions and conventional network operations. Quite to the contrary, embodiments of the disclosure employ methods that, when applied to electronic device and/or user interface technology, improve the functioning of the electronic device itself by and improving the overall user experience to overcome problems specifically arising in the realm of the technology associated with electronic device user interaction.

It will be appreciated that embodiments of the disclosure described herein may be comprised of one or more conventional processors and unique stored program instructions that control the one or more processors to implement, in conjunction with certain non-processor circuits, some, most, or all of the functions of using one or more processors to generate personalized item content for an augmented reality optical projection device in response to the one or more processors detecting commencement of an interactive shopping session in an electronic shopping interactive computing environment by being configured to detect selection of a product capable of presenting visual content on a display of the product during the interactive shopping session, select a visual content offering that is personalized for a user directing the interactive shopping session using a personal knowledge data store associated with a user, generate the personalized item content by integrating renderings of the visual content offering with other renderings of the product, and transmit, using the communication device, the personalized content item to the augmented reality optical projection device as described herein. The non-processor circuits may include, but are not limited to, a radio receiver, a radio transmitter, signal drivers, clock circuits, power source circuits, and user input devices.

As such, these functions may be interpreted as steps of a method to perform detecting, by one or more processors, an interactive session of an electronic shopping interactive computing environment selecting an item with a visual display to be rendered by an augmented reality device, selecting, by the one or more processors, a personalized visual content offering capable of presentation on the visual display and identified as a preferred visual content offering by a personal knowledge data store associated with a user selecting the item, creating, by the one or more processors, an augmented reality rendering of the item delivering the preferred visual content offering to an environment, and transmitting, by the one or more processors using a communication device, the augmented reality rendering to the augmented reality device. Alternatively, some or all functions could be implemented by a state machine that has no stored program instructions, or in one or more application specific integrated circuits (ASICs), in which each function or some combinations of certain of the functions are implemented as custom logic.

Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ASICs with minimal experimentation.

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions.

As used herein, components may be “operatively coupled” when information can be sent between such components, even though there may be one or more intermediate or intervening components between, or along the connection path. The terms “substantially,” “essentially,” “approximately,” “about,” or any other version thereof, are defined as being close to as understood by one of ordinary skill in the art, and in one non-limiting embodiment the term is defined to be within ten percent, in another embodiment within five percent, in another embodiment within one percent and in another embodiment within one-half percent.

The term “coupled” as used herein is defined as connected, although not necessarily directly and not necessarily mechanically. Also, reference designators shown herein in parenthesis indicate components shown in a figure other than the one in discussion. For example, talking about a device (10) while discussing figure A would refer to an element, 10, shown in figure other than figure A.

As noted above, in the rapidly evolving landscape of e-commerce, immersive technologies such as augmented reality (AR) have emerged as transformative tools, enabling users to visualize products within their physical spaces. This capability allows consumers to see how items such as furniture, decor, and electronics will fit in their homes, enhancing the shopping experience by reducing uncertainty and increasing engagement.

However, despite these advancements, current implementations often lack personalization, presenting products in a generic manner without considering individual user preferences or needs. This limitation results in a missed opportunity to create a more engaging and tailored shopping experience that could significantly boost consumer confidence and satisfaction.

Existing AR tools generally show how a product, such as a television or digital frame, appears in a space, but do not take into account individual preferences or needs. The objects remain generic, without adjustments for user-specific tastes. This results in a missed opportunity for businesses to engage users on a deeper level by offering a more tailored experience.

Additionally, while some platforms may allow users to visualize products in their environment, they often do not make use of the potential of digital displays on these products to enhance the user's experience. For example, a television might be shown as a static object without any content, failing to demonstrate the full potential and appeal of the television.

To illustrate by example, consider a tale about our friend, Julie. Julie, a tech-savvy consumer, was on the hunt for a new television to enhance her family's living room experience. While browsing online, she stumbled upon a model that seemed ideal, and the augmented reality (AR) feature allowed her to visualize how the television would fit on her living room wall.

However, the experience left her feeling underwhelmed. The AR tool merely placed the television in her space without any dynamic interaction or personalization, showing a static image that failed to capture her family's distinct tastes and preferences.

This lack of engagement left Julie uncertain about her purchase, prompting her to visit a physical showroom. There, the sales agent quickly assessed the situation and, noticing her children, played a vibrant movie scene that immediately captivated their attention. The vivid display and immersive sound brought the television to life, sparking excitement and convincing Julie of the television's value.

This experience highlighted a significant shortcoming in existing AR systems: the inability to personalize and animate product displays in a way that resonates with individual users. Julie couldn't help but wish for a similar level of engagement from the comfort of her home, underscoring the missed opportunity for e-commerce platforms to create a more tailored and engaging shopping experience.

Advantageously, embodiments of the disclosure provide methods and systems to address these shortcomings by introducing a process for generating personalized item content for a content renderer in an electronic shopping interactive computing environment. Embodiments of the disclosure leverage user-specific data to enhance the visualization of products with displays, such as televisions, by integrating personalized digital content.

In one or more embodiments, a solution to the problem of generic augmented reality (AR) product visualizations in e-commerce involves embedding personalized digital content into the AR experience, thereby enhancing user engagement and satisfaction. In one or more embodiments, this method begins with the user browsing an e-commerce platform and selecting an item, such as a television, to visualize in their physical space using AR technology.

In one or more embodiments, the AR system then renders the selected object in the user's environment, showing how the object fits within their room. To personalize this experience, the system retrieves data from the user's Personal Knowledge Base (PKB), which includes past viewing habits and preferences, such as favorite genres or movies. Based on this data, the system identifies the most relevant digital content to display on the item being viewed.

For instance, if the product is a television, the system might display a scene from the user's favorite film, making the experience more personal and engaging. This digital content is seamlessly integrated into the AR scene, connecting the product with content the user loves, thereby making the product more appealing and enhancing the overall shopping experience.

In one or more embodiments, by retrieving data from a personal knowledge base associated with the user, the system identifies relevant digital content, such as a favorite movie or series, and presents the content on the product's display during the AR visualization. This method not only makes the product more appealing by connecting it with content the user loves but also provides a more immersive and engaging shopping experience. Embodiments of the disclosure offer a significant improvement over existing technologies by personalizing the AR shopping experience and enhancing user satisfaction.

In one or more embodiments, in response to the initiation of an interactive session within an electronic shopping interactive computing environment, an electronic device, equipped with one or more processors, detects user input through a user interface. In one or more embodiments, this input involves the selection of an item that possesses a display, intended to be rendered to the user by a content renderer.

In one or more embodiments, the system retrieves personalized visual content from a personal knowledge data store associated with the user, ensuring that the content is suitable for presentation on the item's display. In one or more embodiments, the one or more processors then generate personalized item content for the content renderer by integrating digital renderings of the personalized visual content with the display renderings of the item. In one or more embodiments, the personalized item content is subsequently transmitted to the content renderer by the one or more processors using a communication device, thereby enhancing the user's shopping experience with tailored visual interactions.

Advantageously, this arrangement allows for a more personalized and engaging shopping experience by tailoring the visual content to the user's preferences, thereby enhancing user satisfaction and potentially increasing purchase likelihood. The integration of personalized content into the shopping experience addresses the common issue of generic product displays, offering a more immersive and relevant interaction.

This method advantageously leverages user-specific data to dynamically adapt the content shown on the product's display, which can significantly improve the user's perception of the product's value and suitability for their needs. By utilizing a personal knowledge data store, the system ensures that the content is not only relevant but also timely, reflecting the user's current interests and preferences. This approach provides a practical application of augmented reality and personalized content delivery, setting this method apart from traditional e-commerce methods that lack such customization.

In one or more embodiments, an electronic device comprises a communication device and one or more processors operable with the communication device. In one or more embodiments, these processors are configured to generate personalized item content specifically for an augmented reality optical projection device.

In one or more embodiments, this process is initiated when the processors detect the commencement of an interactive shopping session within an electronic shopping interactive computing environment. During this session, the processors are designed to detect the selection of a product that is capable of presenting visual content on the product's display.

In one or more embodiments, the processors then select a visual content offering that is personalized for the user directing the interactive shopping session, utilizing a personal knowledge data store associated with the user. The personalized item content can be generated by integrating renderings of the visual content offering with other renderings of the product. In one or more embodiments, the processors subsequently transmit the personalized content item to the augmented reality optical projection device using the communication device, thereby enhancing the user's shopping experience with tailored visual interactions.

Advantageously, this arrangement allows for a seamless integration of personalized content into an augmented reality environment, enhancing the user's shopping experience by providing a tailored visualization of products. By utilizing a personal knowledge data store, the system can select content that is specifically relevant to the user, thereby increasing the likelihood of user engagement and satisfaction.

The integration of personalized content with product renderings in an augmented reality setting offers a more immersive and interactive experience compared to traditional e-commerce methods, which typically lack such customization. This approach not only improves the user's perception of the product but also leverages the capabilities of augmented reality devices to deliver a more engaging and realistic representation of how the product fits into the user's lifestyle

In one or more embodiments, a method pertains to a process implemented in an electronic device for enhancing the user experience during an interactive session within an electronic shopping interactive computing environment. In one or more embodiments, this process involves detecting, by one or more processors, the selection of an item equipped with a visual display intended to be rendered by an augmented reality device.

In one or more embodiments, the process further includes selecting a personalized visual content offering, which is capable of being presented on the visual display and is identified as a preferred visual content offering by a personal knowledge data store associated with the user selecting the item. Subsequently, the process involves creating an augmented reality rendering of the item that delivers the preferred visual content offering to an environment, thereby providing a tailored and immersive shopping experience. The process concludes with transmitting the augmented reality rendering to the augmented reality device using a communication device, ensuring that the personalized content is seamlessly integrated into the user's virtual shopping environment.

Advantageously, this approach allows for a more immersive and personalized shopping experience by leveraging user-specific data to tailor the visual content displayed on the augmented reality device. By integrating personalized content, such as a user's preferred images or videos, into the augmented reality environment, the method enhances user engagement and satisfaction. This personalization addresses the common issue of generic product displays, offering a more relevant and engaging interaction that can increase the likelihood of purchase.

The method's use of a personal knowledge data store to select content ensures that the visual experience is closely aligned with the user's preferences, providing a practical application of augmented reality and personalized content delivery. This not only improves the user's perception of the product but also utilizes the capabilities of augmented reality devices to deliver a more realistic representation of how the product fits into the user's lifestyle. By doing so, the method offers a significant improvement over traditional e-commerce methods, which typically lack such customization

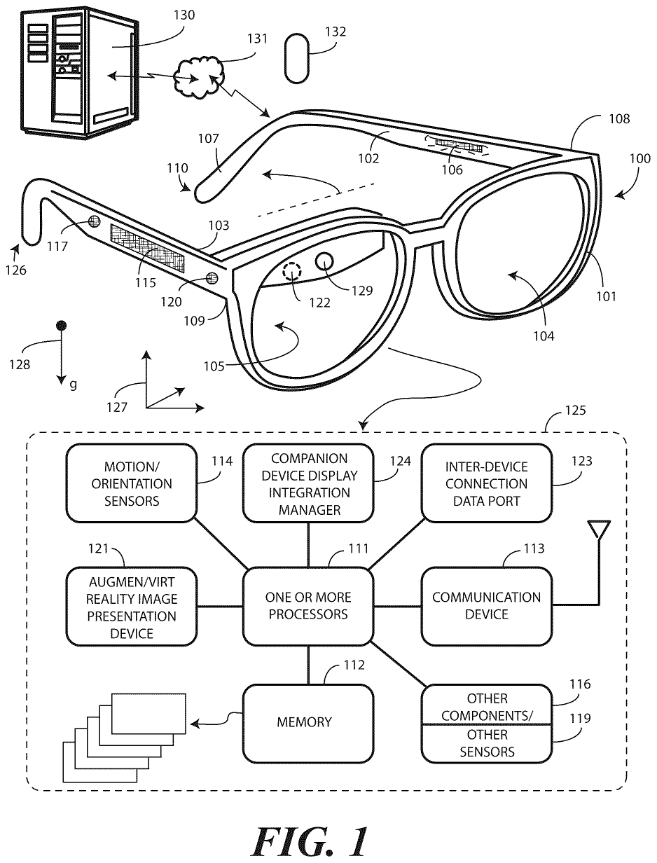

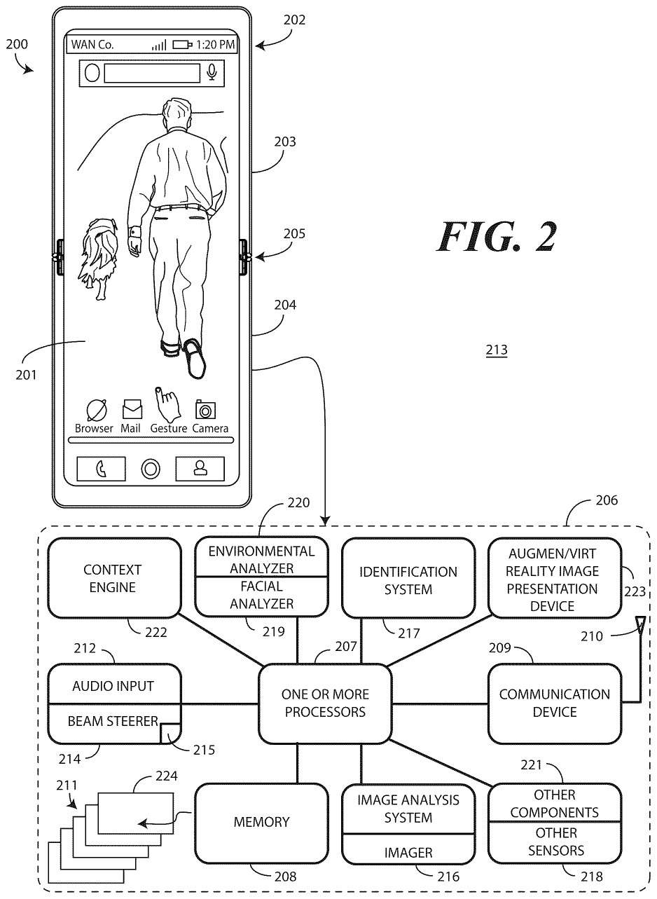

Methods described herein can be performed by any electronic device offering augmented reality capabilities. Illustrating by example, this can be a wearable device, such as a pair of augmented reality glasses. Alternatively, this can be an electronic device having an image capture device and a display, such as a smartphone. The former will be described below with reference to FIG. 1. The latter will be described below with reference to FIG. 2. Other electronic devices offering augmented reality features will be obvious to those of ordinary skill in the art having the benefit of this disclosure.

Turning now to FIG. 1, illustrated therein is one explanatory augmented reality device 100 configured in accordance with one or more embodiments of the disclosure. In the illustrative embodiment of FIG. 1, the augmented reality device 100 comprises augmented reality glasses. However, this is for explanatory purposes only, as the augmented reality device 100 could be configured in any number of other ways as well. Illustrating by example, the augmented reality device 100 could also be configured as any of sunglasses, goggles, masks, shields, or visors. Other forms of the augmented reality device 100 will be obvious to those of ordinary skill in the art having the benefit of this disclosure.

The augmented reality device 100 of FIG. 1 includes a frame 101 and one or more stems 102,103. Here, the one or more stems 102,103 comprise a first stem 102 and a second stem 103. One or more lenses 104,105 can be disposed within the frame 101. The lenses 104,105 can be prescription or non-prescription, and can be clear, tinted, or dark.

In one or more embodiments the stems 102,103 are pivotable from a first position where they are situated adjacent to, and parallel with, the frame 101, to a second, radially displaced open position shown in FIG. 1. However, in other embodiments the stems 102,103 may be fixed relative to the frame 101. In still other embodiments, such as might be the case if the augmented reality device 100 were configured as goggles, the stems 102,103 may be flexible or soft. For example, the stems of goggles are frequently elasticized fabric, which is soft, flexible, pliable, and stretchy. Other types of stems 102,103 will be obvious to those of ordinary skill in the art having the benefit of this disclosure.

In one or more embodiments the stems 102,103 attach to the frame 101 at a first end 108,109 and extend distally from the frame 101 to a second, distal end 110,126. In one embodiment, each stem 102,103 includes a temple portion 106 and an ear engagement portion 107. The temple portion 106 is the portion of the stem 102,103 passing from the frame 101 past the temple of a wearer, while the ear engagement portion 107 engages the wearer's ear to retain the augmented reality glasses to the wearer's head.

Since the augmented reality device 100 is configured as an electronic device, one or both of the frame 101 and the stems 102,103 can comprise one or more electrical components. These electrical components are shown illustratively in a schematic block diagram 125 in FIG. 1. It will be clear to those of ordinary skill in the art having the benefit of this disclosure that the electrical components and associated modules can be used in different combinations, with some components and modules included and others omitted. Components or modules can be included or excluded based upon need or application.

The electronic components can include one or more processors 111. The one or more processors 111 can be disposed in one or both of the stems 102,103 or the frame 101. The one or more processors 111 can be operable with a memory 112. The one or more processors 111, which may be any of one or more microprocessors, programmable logic, application specific integrated circuit device, or other similar device, are capable of executing program instructions and methods described herein. The program instructions and methods may be stored either on-board in the one or more processors 111, or in the memory 112, or in other computer readable media coupled to the one or more processors 111.

The one or more processors 111 can be configured to operate the various functions of the augmented reality device 100 and also to execute software or firmware applications and modules that can be stored in a computer readable medium, such as memory 112. The one or more processors 111 execute this software or firmware, in part, to provide device functionality. The memory 112 may include either or both static and dynamic memory components, may be used for storing both embedded code and user data.

In one or more embodiments, the augmented reality device 100 also includes an optional wireless communication device 113. Where included, the wireless communication device 113 is operable with the one or more processors 111 and is used to facilitate electronic communication with one or more electronic devices or servers or other communication devices across a network. Note that it is possible to combine the one or more processors 111, the memory 112, and the wireless communication device 113 into a single device, or alternatively into devices having fewer parts while retaining the functionality of the constituent parts.

The wireless communication device 113, which may be one of a receiver or transmitter, and may alternatively be a transceiver, operates in conjunction with the one or more processors 111 to electronically communicate through a communication network. For example, in one embodiment, the wireless communication device 113 can be configured to communicate through a traditional cellular network.

Other examples of networks with which the communication circuit may communicate include proprietary networks and direct communication networks. In other embodiments, the wireless communication device 113 can communicate with near field or local area networks, infrared communication circuits, magnetic field modulation circuits, and Wi-Fi circuits. In one or more embodiments, the wireless communication device 113 can be configured to provide messaging functionality to deliver electronic messages to remote devices.

A battery or other energy storage device can be included to provide power for the various components of the augmented reality device 100. It will be obvious to those of ordinary skill in the art having the benefit of this disclosure that other energy storage devices can be used instead of the battery, including a micro fuel cell or an electrochemical capacitor. The battery can include a lithium-ion cell, lithium polymer cell, or a nickel metal hydride cell, such cells having sufficient energy capacity, wide operating temperature range, large number of charging cycles, and long useful life. The battery may also include overvoltage and overcurrent protection and charging circuitry. In one embodiment, the battery comprises a small, lithium polymer cell.

In one or more embodiments, a photovoltaic device 115, such as a solar cell, can be included to recharge the battery. In one embodiment, the photovoltaic device 115 can be disposed along the temple portion 106 of the stems 102,103. In this illustrative embodiment, two solar cells are disposed in the temple portion 106 of each stem 102,103, respectively.

Other components 116 can be optionally included in the augmented reality device 100 as well. For example, in one embodiment one or more microphones can be included as audio capture devices 117. These audio capture devices can be operable with the one or more processors 111 to receive voice input.

Additionally, in one or more embodiments the audio capture devices 117 can capture ambient audio noise. Signals corresponding to captured audio can be transmitted to an electronic device in communication with the augmented reality device 100 or a server or cloud-computing device. The other component 116 can additionally include loudspeakers for delivering audio content to a user wearing the augmented reality device 100.

The other components 116 can also include a motion generation device for providing haptic notifications, vibration notifications, haptic feedback, or vibrational sensations to a user. For example, a piezoelectric transducer, rotational motor, or other electromechanical device can be configured to impart a force or vibration upon the temple portion 106 of the stems 102,103, or alternatively along the frame 101. The motion generation device can provide a thump, bump, vibration, or other physical sensation to the user. The one or more processors 111 can be configured to actuate the motion generation device to deliver a tactile or vibration output alone or in combination with other outputs such as audible outputs.

Similarly, in one or more embodiments the augmented reality device 100 can include a video capture device 129 such as an imager. The imager can be disposed within the frame 101 or stems 102,103. In one or more embodiments, the video capture device 129 can function as a to detect changes in optical intensity, color, light, or shadow in the near vicinity of the augmented reality device 100. As with the audio capture device 117, captured video information can be transmitted to an electronic device, a remote server, or cloud-computing device.

Other sensors 119 can be optionally included in the augmented reality device 100. One example of such a sensor is a global positioning system device for determining where the augmented reality device 100 is located. The global positioning system device can communicate with a constellation of earth orbiting satellites or a network of terrestrial base stations to determine an approximate location. While a global positioning system device is one example of a location determination module, it will be clear to those of ordinary skill in the art having the benefit of this disclosure that other location determination devices, such as electronic compasses or gyroscopes, could be used as well.

The other sensors 119 can also include an optional user interface. The user interface can be used, for example, to activate the circuit components or turn them OFF, control sensitivity of the other sensors 119, receive user input, and so forth. The user interface, where included, can be operable with the one or more processors 111 to deliver information to, and receive information from, a user. The user interface can include a rocker switch, slider pad, button, touch-sensitive surface, or other controls, and optionally a voice command interface. These various components can be integrated together.

In one or more embodiments, an audio output device 120, such as a loudspeaker or other transducer, can deliver audio output to a user. For example, piezoelectric transducers can be operably disposed within the stems 102,103. Actuation of the piezoelectric transducers can cause the stems 102,103 to vibrate, thereby emitting acoustic output. More traditional audio output devices 120, such as loudspeakers, can be used as well. The inclusion of both the audio output device 120 and the haptic device allows both audible and tactile feedback to be delivered.

In one or more embodiments, the augmented reality device 100 includes an augmented reality image presentation device 121 operable to deliver augmented reality imagery to a user. This augmented reality imagery is referred to as an augmented reality environment because it is this imagery that the user experiences when interacting with the augmented reality device 100. The augmented reality image presentation device 121 can be operable with a projector 122. In the illustrative embodiment of FIG. 1, the frame 101 supports the projector 122. In one or more embodiments the projector 122 is configured to deliver images to a holographic optical element when the augmented reality device 100 is operating in an augmented reality mode of operation.

In one embodiment, the projector 122 is a modulated light projector operable to project modulated light images along a surface or holographic optical element. In another embodiment, the projector 122 is a thin micro projector. In another embodiment, the projector 122 can comprise a laser projector display module. Other types of projectors will be obvious to those of ordinary skill in the art having the benefit of this disclosure.

In one or more embodiments, the projector 122 can include a lens and a spatial light modulator configured to manipulate light to produce images, including the virtual elements that appear in the augmented reality environment. The projector 122 can include a light source, such as a single white light emitting diode, multiple separate color light emitting diodes, or multiple separate color laser diodes that deliver visible light to the spatial light modulator through a color combiner. The augmented reality image presentation device 121 can drive the spatial light modulator to modulate the light to produce images. The spatial light modulator can be optically coupled (e.g., by free space propagation) to the lens and/or a beam steerer. Where used, a beam steerer serves to steer a spatially modulated light beam emanating from the spatial light modulator through the lens to create images.

One or more motion detectors 114 can be configured as an orientation detector that determines an orientation and/or movement of the augmented reality device 100 in three-dimensional space. Illustrating by example, the motion detectors 114 can include an accelerometer, gyroscopes, or other device to detect device orientation and/or motion of the augmented reality device 100 in three-dimensional space 127. Using an accelerometer as an example, an accelerometer can be included to detect motion of the augmented reality device 100. Additionally, the accelerometer can be used to sense some of the gestures of the user, such as those made by predefined movements of the head.

The motion detectors 114 can determine the spatial orientation and/or motion of an augmented reality device 100 in three-dimensional space 127 by, for example, detecting a gravitational direction 128 and acceleration due to applied forces. In addition to, or instead of, an accelerometer, an electronic compass can be included to detect the spatial orientation of the augmented reality device 100 relative to the earth's magnetic field. Similarly, one or more gyroscopes can be included to detect rotational orientation of the augmented reality device 100.

In one or more embodiments, the one or more motion detectors 114 comprise one or more inertial motion units. In one embodiment, the augmented reality device 100 includes only a single inertial motion unit that is situated, for example, in one of the stems 102,103 or, alternatively, the frame 101. In another embodiment, the augmented reality device 100 optionally includes a second inertial motion unit that is situated in the other of the stems 102,103, or alternatively in the frame 101. Additional inertial motion units can be included as necessitated by a particular application. For example, the augmented reality device 100 could include three inertial motion units, with one situated in stem 102, another situated in stem 103, and a third situated in the frame 101.

In one or more embodiments, each inertial motion unit comprises a combination of one or more accelerometers and one or more gyroscopes, and optionally one or more magnetometers, to determine the orientation, angular velocity, and/or specific force of the augmented reality device 100. When included in the augmented reality device 100, these inertial motion units can be used as orientation sensors to measure the orientation of one or more of the frame 101 and/or stems 102,103 in three-dimensional space 127. Similarly, the inertial motion units can be used as orientation sensors to measure the motion of one or more of the frame 101 and/or stems 102,103 in three-dimensional space 127. The inertial motion units can be used to make other measurements as well.

In one or more embodiments, the inertial motion unit(s) can be configured as orientation detectors that determine the orientation and/or movement of the augmented reality device 100 in three-dimensional space 127. Illustrating by example, the inertial motion unit can determine the spatial orientation of the augmented reality device 100 in three-dimensional space 127 by, for example, detecting a gravitational direction 128 using an accelerometer. In addition to, or instead of, an accelerometer, magnetometers can be included to detect the spatial orientation of the electronic device relative to the earth's magnetic field. Similarly, one or more gyroscopes can be included to detect rotational orientation of the augmented reality device 100.

Motion of the augmented reality device 100 can similarly be detected. The accelerometers, gyroscopes, and/or magnetometers can be used as a motion detector 114 in the augmented reality device 100. The inertial motion unit(s) can also be used to determine the spatial orientation of the augmented reality device 100 in three-dimensional space 127 by detecting a gravitational direction 128. Similarly, the gyroscopes can be included to detect rotational motion of the augmented reality device 100.

In one or more embodiments, the inertial motion unit(s) determine an orientation of the device housing in which it is situated in three-dimensional space. For example, where only one inertial motion unit is included in the first stem 102, this inertial motion unit is configured to determine an orientation, which can include measurements of azimuth, plumb, tilt, velocity, angular velocity, acceleration, and angular acceleration, of the first stem 102. Similarly, where two inertial motion units are included, with one inertial motion unit being situated in the first stem 102 and another inertial motion unit being situated in the second stem 103, each inertial motion unit determines the orientation of its respective stem. Each inertial motion unit can determine measurements of azimuth, plumb, tilt, velocity, angular velocity, acceleration, angular acceleration, and so forth. In one or more embodiments, each inertial motion unit can determine deviation of the augmented reality device 100 from each axis of the three-dimensional space 127 across time in radians per second.

In one or more embodiments, each inertial motion unit delivers these orientation measurements to the one or more processors 111 in the form of orientation determination signals. Said differently, in one or more embodiments each inertial motion unit outputs an orientation determination signal comprising the determined orientation of its respective device housing.

In one or more embodiments, the augmented reality device 100 includes a companion device display integration manager 124. The companion device display integration manager 124 can be used to communicate with a companion electronic device. Illustrating by example, when another device transmits personalized item content for the augmented reality device to present as a content renderer, the companion device display integration manager 124 can deliver that information to the augmented reality image presentation device 121 for presentation to the user as one or more virtual elements in the augmented reality environment via the projector 122.

The augmented reality device 100 of FIG. 1 can operate as a stand-alone electronic device in one or more embodiments. However, in other embodiments, the augmented reality device 100 can operate in tandem with another electronic device, via wireless electronic communication using the wireless communication device 113, or via a wired connection channel 123 to form an augmented reality system.

In one or more embodiments, the augmented reality device 100 can use the communication device 113 to communicate with a remote electronic device 130, such as a server or network device, across a network 131. In one or more embodiments, in response to initiation of an interactive session in an electronic shopping interactive computing environment operating on one or more processors of the remote electronic device 130, the one or more processors detect, by a user interface operable with the one or more processors, user input from a user selecting an item having a display to be rendered to the user by the augmented reality device 100. In one or more embodiments, the one or more processors retrieve, from a personal knowledge data store associated with the user, personalized visual content suitable for presentation by the item on the display.

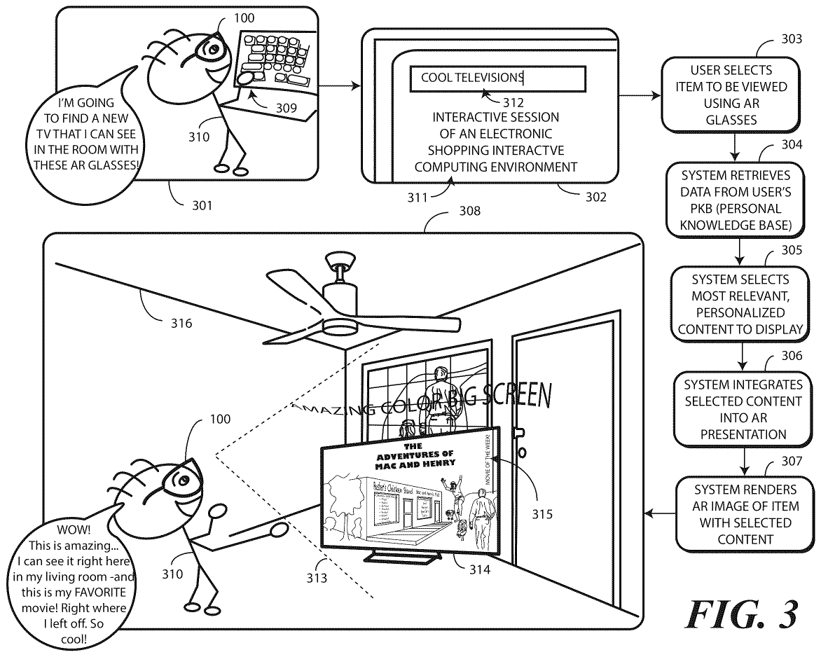

In one or more embodiments, the one or more processors generate personalized item content 132 for the augmented reality device 100 by causing digital renderings of the personalized visual content to be presented on the display in renderings of the item. In one or more embodiments, the one or more processors transmit the personalized item content 132 across the network 131 to the augmented reality device 100. As will be illustrated and described in FIG. 3 below, in one or more embodiments this allows a user to see the item presenting their favorite television show, movie, or video series.

Illustrating by example, in one or more embodiments the augmented reality device 100, as illustrated in FIG. 1, is configured to receive personalized item content 132, enabling users to visualize an item, such as a television, within their home environment while displaying their favorite content. For instance, consider a user who is an ardent fan of the classic Adam West television show, Batman.

This user has fond memories of watching the caped crusader's adventures, particularly the episode titled “The Purr-fect Crime/Better Luck Next Time,” which features the iconic villain Catwoman. The user's admiration for the show stems from its nostalgic charm, witty dialogue, and the portrayal of Batman by Adam West, which has left a lasting impression.

By leveraging the augmented reality device 100, the user can see, for example, a virtual representation of a television in their living room, seamlessly integrated with a scene from this beloved episode. This immersive experience not only evokes a sense of nostalgia but also vividly demonstrates the television's display capabilities, making the user more inclined to purchase the television. The ability to see their favorite show in such a personalized and engaging manner significantly enhances the user's shopping experience, bridging the gap between mere visualization and emotional connection, which influences their purchasing decision.

While the augmented reality device 100 of FIG. 1 is configured to present personalized item content directly to a user, alternative embodiments utilize a device equipped with an image capture device and a display to achieve similar functionality. Such a device captures images of the user's environment and augments these images with augmented reality (AR) elements, including personalized item content. The personalized content is selected based on user preferences stored in a personal knowledge data store, ensuring that the augmented reality experience is tailored to the individual user. The augmented images are then presented on the device's display, allowing the user to visualize how the personalized content integrates with their physical space. This approach not only enhances the user's interaction with the product but also provides a more immersive and engaging experience by seamlessly blending digital content with the real-world environment. Turning now to FIG. 2, illustrated therein is one such electronic device 200.

The electronic device 200 of FIG. 2 is a portable electronic device and is shown as a smartphone for illustrative purposes. However, it should be obvious to those of ordinary skill in the art having the benefit of this disclosure that other electronic devices may be substituted for the explanatory smart phone of FIG. 2. For example, the electronic device 200 could equally be a conventional desktop computer, palm-top computer, a tablet computer, a gaming device, a media player, or other device.

This illustrative electronic device 200 includes a display 201, which may optionally be touch-sensitive. Users can deliver user input to the display 201, which serves as a user interface for the electronic device 200. In one embodiment, users can deliver user input to the display 201 of such an embodiment by delivering touch input from a finger, stylus, or other objects disposed proximately with the display 201. In one embodiment, the display 201 is configured as an active-matrix organic light emitting diode (AMOLED) display. However, it should be noted that other types of displays, including liquid crystal displays, would be obvious to those of ordinary skill in the art having the benefit of this disclosure.

The explanatory electronic device 200 of FIG. 2 also includes a device housing 202. In one embodiment, the device housing 202 includes two housing members, namely, a first device housing 203 that is coupled to a second device housing 204 by a hinge 205 such that the first device housing 203 is pivotable about the hinge 205 relative to the second device housing 204 between a closed position and an axially displaced open position. In other embodiments, the device housing 202 will be rigid and will include no hinge.

In still other embodiments, the device housing 202 will be manufactured from a flexible material such that it can be bent and deformed. Where the device housing 202 is manufactured from a flexible material or where the device housing 202 includes a hinge, the display 201 can be manufactured on a flexible substrate such that it bends. In one or more embodiments, the display 201 is configured as a flexible display that is coupled to the first device housing 203 and the second device housing 204, spanning the hinge 205. Features can be incorporated into the device housing 202, including control devices, connectors, and so forth.

Also shown in FIG. 2 is an explanatory block diagram schematic 206 of the explanatory electronic device 200. In one or more embodiments, the block diagram schematic 206 is configured as a printed circuit board assembly disposed within the device housing 202 of the electronic device 200. Various components can be electrically coupled together by conductors, or a bus disposed along one or more printed circuit boards.

The illustrative block diagram schematic 206 of FIG. 2 includes many different components. Embodiments of the disclosure contemplate that the number and arrangement of such components can change depending on the particular application. Accordingly, electronic devices configured in accordance with embodiments of the disclosure can include some components that are not shown in FIG. 2, and other components that are shown may not be needed and can therefore be omitted.

In one embodiment, the electronic device includes one or more processors 207. In one embodiment, the one or more processors 207 can include an application processor and, optionally, one or more auxiliary processors. One or both of the application processor or the auxiliary processor(s) can include one or more processors. One or both of the application processor or the auxiliary processor(s) can be a microprocessor, a group of processing components, one or more ASICs, programmable logic, or other type of processing device.

The application processor and the auxiliary processor(s) can be operable with the various components of the block diagram schematic 206. Each of the application processor and the auxiliary processor(s) can be configured to process and execute executable software code to perform the various functions of the electronic device with which the block diagram schematic 206 operates. A storage device, such as memory 208, can optionally store the executable software code used by the one or more processors 207 during operation.

In this illustrative embodiment, the block diagram schematic 206 also includes a communication device 209 that can be configured for wired or wireless communication with one or more other devices or networks. The networks can include a wide area network, a local area network, and/or personal area network. The communication device 209 may also utilize wireless technology for communication, such as, but are not limited to, peer-to-peer or ad hoc communications such as HomeRF, Bluetooth and IEEE 802.11, and other forms of wireless communication such as infrared technology. The communication device 209 can include wireless communication circuitry, one of a receiver, a transmitter, or transceiver, and one or more antennas 210.

In one embodiment, the one or more processors 207 can be responsible for performing the primary functions of the electronic device with which the block diagram schematic 206 is operational. For example, in one embodiment the one or more processors 207 comprise one or more circuits operable with the display 201 to present presentation information to a user. The executable software code used by the one or more processors 207 can be configured as one or more modules 211 that are operable with the one or more processors 207. Such modules 211 can store instructions, control algorithms, and so forth.

Illustrating by example, in one or more embodiments the one or more processors 207 are configured to generate personalized content item 224 for augmented reality optical projection on the display 201 and/or for the communication device 209 to deliver to an augmented reality device (100) such as the one shown in FIG. 1 in response to the one or more processors 207 detecting commencement of an interactive shopping session in an electronic shopping interactive computing environment.

In one or more embodiments, the one or more processors 207 do this by being configured to detect the selection of a product capable of presenting visual content on a display of the product during the interactive shopping session. In one or more embodiments, the product comprises a television. Other examples of products will be obvious to those of ordinary skill in the art having the benefit of this disclosure.

In one or more embodiments, the one or more processors 207 select a visual content offering that is personalized for a user directing the interactive shopping session using a personal knowledge data store associated with a user. In one or more embodiments, the visual content offering comprises one of a video, a television show, or a movie.

In one or more embodiments, the one or more processors 207 generate the personalized content item 224 by integrating renderings of the visual content offering with other renderings of the product. In one or more embodiments, the one or more processors cause the display 201 to present the personalized content item 224. In other embodiments, the one or more processors 207 transmit, using the communication device 209, the personalized content item 224 to an augmented reality optical projection device.

In one or more embodiments, the block diagram schematic 206 includes an audio input/processor 212. The audio input/processor 212 is operable to receive audio input from an environment 213 about the electronic device 200. The audio input/processor 212 can include hardware, executable code, and speech monitor executable code in one embodiment.

The audio input/processor 212 can be operable with one or more predefined identification references stored in memory 208. With reference to audio input, the predefined identification references can comprise representations of basic speech models, representations of trained speech models, or other representations of predefined audio sequences that are used by the audio input/processor 212 to receive and identify voice commands that are received with audio input captured by an audio capture device.

In one embodiment, the audio input/processor 212 can include a voice recognition engine. Regardless of the specific implementation utilized in the various embodiments, the audio input/processor 212 can access various speech models stored with the predefined identification references to identify speech commands, languages being spoken, and other information.

The audio input/processor 212 can include a beam steering engine 214 comprising one or more microphones 215. Input from the one or more microphones 215 can be processed in the beam steering engine 214 such that the one or more microphones define a virtual microphone. This virtual microphone can define an acoustic reception cone that can be virtually “steered” around the electronic device 200.

Alternatively, actual steering can occur as well, such as switching between a left and right microphone or a front and back microphone or switching various microphones ON and OFF individually. In one or more embodiments, two or more microphones 215 can be included for selective beam steering by the beam steering engine 214.

Illustrating by example, a first microphone can be located on a first side of the electronic device 200 for receiving audio input from a first direction, while a second microphone can be placed on a second side of the electronic device 200 for receiving audio input from a second direction. These microphones can be “steered” by selectively turning them ON and OFF.

The beam steering engine 214 can then select between the first microphone and the second microphone to beam steer audio reception toward an object, such as a user delivering audio input. This beam steering can be responsive to input from other sensors, such as imagers, facial depth scanners 219, thermal sensors, or other sensors. For example, an imager 216 can estimate a location of a person's face and deliver signals to the beam steering engine 214 alerting it in which direction to focus the acoustic reception cone and/or steer the first microphone and the second microphone, thereby adding confirmation to audio steering and saving time. Where multiple people are around the electronic device 200, this steering advantageously directs a beam reception cone toward a particular person so that languages spoken, language preferences, and other information about the person's speech can be ascertained.

Alternatively, the beam steering engine 214 processes and combines the signals from two or more microphones to perform beam steering. The one or more microphones 215 can be used for voice commands and/or for language recognition. In response to control of the one or more microphones 215 by the beam steering engine 214, a user location direction can be determined. The beam steering engine 214 can then select between the first microphone and the second microphone to beam steer audio reception toward the user. Alternatively, the audio input/processor 212 can employ a weighted combination of the microphones to beam steer audio reception toward the user.

The one or more processors 207 can perform filtering operations on audio input received by the audio input/processor 212. For example, in one embodiment the one or more processors 207 can filter the audio input into identifiable audio input, i.e., first audio input, and other audio input that is not identifiable, i.e., second audio input.

Various sensors 218 can be operable with the one or more processors 207. One example of a sensor that can be included with the various sensors 218 is a touch sensor. The touch sensor can include a capacitive touch sensor, an infrared touch sensor, resistive touch sensors, or another touch-sensitive technology. Capacitive touch-sensitive devices include a plurality of capacitive sensors, e.g., electrodes, which are disposed along a substrate. Each capacitive sensor is configured, in conjunction with associated control circuitry, e.g., the one or more processors 207, to detect an object in close proximity with—or touching—the surface of the display 201 or the device housing 202 of the electronic device 200 by establishing electric field lines between pairs of capacitive sensors and then detecting perturbations of those field lines.

Another example of a sensor that can be included with the various sensors 218 is a geo-locator that serves as a location detector. In one embodiment, location detector is able to determine location data when authenticating a user. Location can be determined by capturing the location data from a constellation of one or more earth orbiting satellites, or from a network of terrestrial base stations to determine an approximate location. The location detector may also be able to determine location by locating or triangulating terrestrial base stations of a traditional cellular network, or from other local area networks, such as Wi-Fi networks.

Another example of a sensor that can be included with the various sensors 218 is an orientation detector operable to determine an orientation and/or movement of the electronic device 200 in three-dimensional space. Illustrating by example, the orientation detector can include an accelerometer, gyroscopes, or other device to detect device orientation and/or motion of the electronic device 200. Using an accelerometer as an example, an accelerometer can be included to detect motion of the electronic device. Additionally, the accelerometer can be used to sense some of the gestures of the user, such as one talking with their hands, running, or walking.

The orientation detector can determine the spatial orientation of an electronic device 200 in three-dimensional space by, for example, detecting a gravitational direction. In addition to, or instead of, an accelerometer, an electronic compass can be included to detect the spatial orientation of the electronic device relative to the earth's magnetic field. Similarly, one or more gyroscopes can be included to detect rotational orientation of the electronic device 200.

An identification system 217 is operable with the one or more processors 207. In one or more embodiments, the identification system 217 is operable with both the one or more processors 207 and the communication device 209. The identification system 217, operating with the one or more processors 207, can cause the communication device 209, in response to the communication device 209 detecting establishment of an electrical communication channel with an augmented reality device (100) such as that described above with reference to FIG. 1, to query the augmented reality device (100) to determine what type of device the augmented reality device (100) is. Illustrating by example, the identification system 217 can cause the communication device 209 to query the augmented reality device (100) to determine whether the augmented reality device (100) is a projector, a monitor, or a wearable glass projection device.

In one or more embodiments, when the augmented reality device (100) comprises augmented reality glasses, as would be the case if the augmented reality device (100) were that of FIG. 1 above, the one or more processors 207 can transmit, using the communication device 209, the personalized content item 224 generated by an augmented reality renderer 223 to the augmented reality optical projection device. In other embodiments, an augmented reality presentation device can synthesize images received from an image capture device 216 with the personalized content item 224 and present at synthesized content on the display 201.

Other components 221 operable with the one or more processors 207 can include output components such as video, audio, and/or mechanical outputs. For example, the output components may include a video output component or auxiliary devices including a cathode ray tube, liquid crystal display, plasma display, incandescent light, fluorescent light, front or rear projection display, and light emitting diode indicator. Other examples of output components include audio output components such as a loudspeaker disposed behind a speaker port or other alarms and/or buzzers and/or a mechanical output component such as vibrating or motion-based mechanisms.

The other components 221 can also include proximity sensors. The proximity sensors fall into one of two camps: active proximity sensors and “passive” proximity sensors. Either the proximity detector components or the proximity sensor components can be generally used for gesture control and other user interface protocols.

The other components 221 can optionally include a barometer operable to sense changes in air pressure due to elevation changes or differing pressures of the electronic device 200. The other components 221 can also optionally include an environmental sensor 220 such as a light sensor that detects changes in optical intensity, color, light, or shadow in the environment of an electronic device. This can be used to make inferences about context such as weather or colors, walls, fields, and so forth, or other cues. An infrared sensor can be used in conjunction with, or in place of, the light sensor. The infrared sensor can be configured to detect thermal emissions from an environment about the electronic device 200. Similarly, a temperature sensor can be configured to monitor temperature about an electronic device.

A context engine 222 can then be operable with the various sensors to detect, infer, capture, and otherwise determine persons and actions that are occurring in an environment 213 about the electronic device 200. For example, where included one embodiment of the context engine 222 determines assessed contexts and frameworks using adjustable algorithms of context assessment employing information, data, and events. These assessments may be learned through repetitive data analysis. Alternatively, a user may employ a menu or user controls via the display 201 to enter various parameters, constructs, rules, and/or paradigms that instruct or otherwise guide the context engine 222 in detecting multi-modal social cues, emotional states, moods, and other contextual information. The context engine 222 can comprise an artificial neural network or other similar technology in one or more embodiments.

It is to be understood that in both FIG. 1 and FIG. 2, the elements illustrated are provided for illustrative purposes only in accordance with embodiments of the disclosure. Neither is intended to be a complete schematic diagram of the various components required. Therefore, other electronic devices in accordance with embodiments of the disclosure may include various other components obvious to those of ordinary skill in the art having the benefit of this disclosure, but not shown in FIG. 1 or FIG. 2, or may include a combination of two or more components or a division of a particular component into two or more separate components, and still be within the scope of the present disclosure.

Now that the general hardware elements have been described, attention will turn to methods of using such hardware in accordance with one or more embodiments of the disclosure. Turning now to FIG. 3, illustrated therein are one or more method steps for using the augmented reality device 100 of FIG. 1 in accordance with one or more embodiments of the disclosure.

Beginning at step 301, a user 310 is wearing an augmented reality device 100 in accordance with one or more embodiments of the disclosure. At step 301, the augmented reality device 100 is operable with a companion electronic device 309, which is a computer in this illustrative example.

At step 301, the user 310 uses the computer to initiate an interactive session in an electronic shopping interactive computing environment 311. As shown at step 302, the user enters a search string 312 searching for “cool televisions” to initiate the interactive session of the electronic shopping interactive computing environment. In one or more embodiments, this search string returns a list of televisions from which the user 310 can use.

At step 303, in response to the initiation of the interactive session in an electronic shopping interactive computing environment 311 operating on one or more processors of the computer, a user interface of the computer, shown as a keyboard at step 301, detects user input from the user 310 selecting an item having a display to be rendered to the user by a content renderer. In this illustrative example, the item having the display is a television and the content renderer comprises an augmented reality optical presentation device, namely, the augmented reality device 100 shown in FIG. 1.

At step 304, one or more processors of the computer retrieve, from a personal knowledge data store associated with the user, personalized visual content suitable for presentation by the item on the display. In one or more embodiments, the personalized visual content comprises one of a video, a television show, or a movie.

In one or more embodiments, the one or more processors of the computer access the personalized knowledge data store from a remote electronic device across a network using a communication device. For example, in one or more embodiments the retrieving from the personal knowledge data store associated with the user the personalized visual content comprises performing a web-scraping technique to identify content offerings previously consumed by the user. Illustrating by example, the one or more processors of the computer may contact video streaming service providers with which the user 310 has an account to determine what shows, movies, or television series the user 310 likes to watch.

At step 305, the one or more processors select a personalized visual content offering capable of presentation on the item selected by the user 310 at step 303. In one or more embodiments, the personalized visual content comprises one of a video, a television show, or a movie. Illustrating by example, as shown at step 308, in this example the personalized visual content comprises a movie entitled “The Adventures of Mac and Henry.”

This engaging buddy movie follows the escapades of Mac and Henry, two adventurous friends with a penchant for culinary exploration. Their journey begins with a simple yet intriguing plan: to dine at Buster's Chicken Stand, a renowned eatery celebrated for its diverse offerings of eight distinct styles of chicken.

However, the true allure of their adventure lies in the proximity of Buster's to the legendary Mac and Henry's Pub. Known far and wide for its extensive and well-curated selection of digestifs, the pub promises to be an ideal venue for Mac and Henry to indulge in a post-meal ritual. As they savor each style of chicken, they envision a lavish meal where no culinary delight is spared, culminating in a visit to the pub to wash down their feast with an exceptional selection of digestifs. This narrative not only highlights the personalized content's relevance to the user but also immerses them in the whimsical and appetizing world of Mac and Henry's culinary quest

In one or more embodiments, the personalized visual content comprises a most-consumed visual content offering associated with the user 310. Illustrating by example, if the user 310 watches five different television series, but really likes to binge on one particular series every day, step 305 may select that most-watched series as the personalized content item, and so forth.

Where, for example, the item is a television, at step 305 the one or more processors select a personalized visual content offering suitable for presentation on a visual display of the television. In one or more embodiments, the personalized visual content offering is identified as a preferred visual content offering by a personal knowledge data store associated with the user 310 selecting the item at step 303. Illustrating by example, the preferred content visual offering can comprise images or video suitable for presentation on the television set selected.

In one or more embodiments, the selection occurring at step 305 is performed using an artificial intelligence process. Illustrating by example, in one or more embodiments an artificial intelligence system analyzes the user's historical data, preferences, and consumption patterns stored within the personal knowledge data store to identify content that aligns with the user's interests. In one or more embodiments, this process involves utilizing machine learning algorithms to evaluate various data points, such as previously watched movies, favorite genres, and frequently accessed digital content, to predict the most relevant visual content offering for the user.

By leveraging artificial intelligence, the system can dynamically adapt to changes in user preferences, ensuring that the selected content is both timely and engaging. This personalized selection process enhances the user's experience by providing content that resonates with their individual tastes, thereby increasing the likelihood of user satisfaction and engagement during the interactive shopping session.

At step 306, the one or more processors of the computer generate personalized item content 313 for the content renderer by causing digital renderings of the personalized visual content to be presented on the display in renderings of the item. In one or more embodiments, the generating at step 306 occurs only when the content renderer comprises an augmented reality optical projection device, as is the case in FIG. 3.

In one or more embodiments, the generation of personalized item content 313 for the content renderer is accomplished by utilizing one or more processors to create digital renderings of personalized visual content, which are then presented on the display in renderings of the item. This process can be achieved through various methods, each offering distinct advantages.

For instance, the processors may employ machine learning algorithms to analyze user preferences and historical data, thereby selecting the most relevant visual content, such as a favorite movie scene or a frequently watched television show, to be displayed on a product like a television. This approach not only enhances user engagement by providing a tailored viewing experience but also increases the likelihood of purchase by demonstrating the product's capabilities in a context that resonates with the user.

Another method involves integrating real-time data from the user's personal knowledge base to dynamically update the content displayed, ensuring that the content remains current and aligned with the user's evolving interests. This real-time personalization can significantly improve user satisfaction by offering a more immersive and interactive shopping experience.

Additionally, the system can adapt the content based on the environment in which the product is visualized, such as displaying family-friendly content when the product is placed in a living room setting, thereby enhancing the relevance and appeal of the product in its intended use case. These methods collectively provide a robust framework for delivering personalized content that not only showcases the product's features but also aligns with the user's personal preferences, driving higher engagement and conversion rates.

In one or more embodiments, step 306 further comprises transmitting, by the one or more processors using a communication device, the personalized item content 313 to the content renderer. Step 307 then rendered the personalized item content to the user 310.

As shown at step 308, this allows the user 310 to stand in his house 316 and see a virtual depiction of the item he selected, namely, a television 314, presenting his favorite movie 315, “The Adventures of Mac and Henry,” right where he last left off. This occurs because in one or more embodiments step 305 further comprises detecting, by the one or more processors of the computer from signals received by the communication device from the content renderer, a location where the content renderer will render the personalized item content. In this example, it's the mid-point of the movie, which is where the user 310 most recently stopped watching. Accordingly, step 307 comprises modifying, by the one or more processors, the personalized item content to correspond to the location. As shown, the user 310 is blown away when the augmented reality device 100 allow him to see not only the television 314, but his favorite movie 315 right in his living room. Indeed, the user 310 exclaims, “WOW! This is amazing . . . I can see it right here in my living room—and this is my FAVORITE movie! Right where I left off. So cool!”

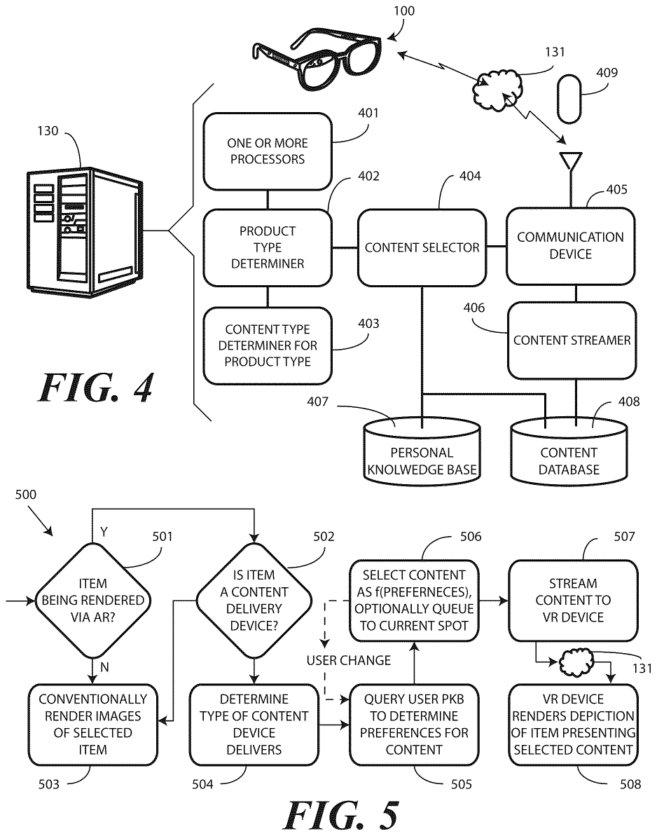

Turning now to FIG. 4, illustrated therein is one explanatory system in accordance with one or more embodiments of the disclosure. The system includes an augmented reality device 100 a companion electronic device 130 that is in communication with the augmented reality device 100 across a network 131. In this illustrative embodiment, the companion electronic device 130 is a remote electronic device that is a companion electronic device of, and operable with, the augmented reality device 100, which is an augmented reality optical projection device. As shown, the companion electronic device 130 comprises one or more processors 401 and a communication device 405 that is in communication with the augmented reality device 100.

In one or more embodiments, the companion electronic device 130 comprises a product type determiner 402. In one or more embodiments, the product type determiner 402 detects, using the one or more processors 401, an interactive session of an electronic shopping interactive computing environment selecting an item with a visual display to be rendered by the augmented reality device 100. A content type determiner 403 then determines what type of visual content the item typically displays.

Illustrating by example, if the item is a television, content type determiner 403 may select images or video. The images or video may comprise television shows or movies, as previously described. By contrast, if the item selected were a gaming console, the content type determiner 403 may determine that a video game will be presented on its display, and so forth.

A content selector 404 then selects a personalized visual content offering capable of presentation on the visual display that identified as a preferred visual content offering by a personal knowledge data store 407 associated with a user selecting the item. In one or more embodiments, the “personal knowledge data store” 407 functions as a digital storage system that holds information about a user's preferences and habits. Consider this as a personalized database that keeps track of what the user likes, such as their favorite movies, television shows, or other digital content with which a user frequently engages.

In one or more embodiments, the personal knowledge data store 407 gathers data about a user's viewing habits and preferences. For example, the data store might know that a particular user loves watching action movies or that the user frequently binge-watches a particular television series. These content offerings can be stored in a content database 408. In one or more embodiments, the visual content offering selected from the content database 408 is identified as a favorite movie, video, or television show in the personal knowledge data store 407.

In one or more embodiments, the visual content offering selected from the content database 408 is a partially consumed visual content offering. In one or more embodiments, this allows the content streamer 406 and the one or more processors 401 to generate the personalized item content by integrating renderings of unconsumed portions of the visual content offering with the other renderings of the product.

When a particular user selects an item in an electronic shopping interactive computing environment to be rendered on an augmented reality device 100, a content streamer 406 can create, by the one or more processors 401, an augmented reality rendering 409 of the item delivering the preferred visual content offering to an environment. The communication device 405 can then transmit the augmented reality rendering 409 to the augmented reality device 100 for presentation to a user.

As such, using the system of FIG. 4, when one is shopping online and using augmented reality (AR) to visualize a product like a television in one's home, the personal knowledge data store 407 helps to tailor the experience. The personal knowledge data store 407 facilitates this when the content selector 404 selects content from the content database 408 the person is likely to enjoy. The content streamer 406 then displays the content on the product's screen in the augmented reality environment.

By using the information from the personal knowledge data store 407, the system can make the product visualization more engaging and relevant to the user. Instead of just seeing a generic image on the TV screen, the user might see a scene from your favorite movie, making the shopping experience more personal and exciting. In effect, use of the personal knowledge data store 407 allows for a determination of what type of content the user would show on that type of display, with the content streamer 406 showing that personalized content in the rendering of the selected item.

The system of FIG. 4 detects the selection of something having a digital visual display, determines what type of content would be displayed by that type of device, fetches personalized content the user would be likely to have that device display, and renders it on the display of the item as if the item were presenting it. In summary, the personal knowledge data store is like a smart assistant that knows your digital content preferences and uses that information to enhance your online shopping experience by personalizing what you see in augmented reality.

Turning now to FIG. 5, illustrated therein is another explanatory method 500 in accordance with one or more embodiments of the disclosure. The method 500 begins at decision 501, which determines whether content is being rendered by a device with augmented reality functionality, such as a smartphone with an image capture device and display, augmented reality glasses, or another device having augmented reality features.

Decision 501 of the method 500 in FIG. 5 can, in one or more embodiments, determine whether content is to be rendered by a device with augmented reality (AR) functionality by employing multiple techniques, each offering distinct advantages. One technique involves detecting the presence of an image capture device and display, which are indicative of AR capabilities, as found in smartphones and tablets. This method leverages the device's built-in hardware features to ascertain the device's suitability for AR content rendering, ensuring compatibility and optimal performance.

Another technique utilizes software-based detection, where the device's operating system or installed applications are analyzed to identify AR functionalities, such as ARCore or ARKit, which are commonly used in smartphones and tablets. This approach allows for a more flexible determination, accommodating devices that may not have dedicated AR hardware but can still support AR experiences through software enhancements.

Additionally, the method can incorporate user input or device settings to confirm AR capabilities, providing a user-driven approach that ensures the device is configured correctly for AR content. By employing these techniques, decision 501 ensures that content is rendered on devices capable of delivering an immersive AR experience, enhancing user engagement and satisfaction.

In conventional electronic shopping interactive computing environments, when decision 501 determines that the item is not being rendered by a device with augmented reality features, step 503 typically involves rendering images of the selected items in a two-dimensional format on the user's display screen. In one or more embodiments, this process involves displaying static images or a series of images that represent the item from various angles, allowing the user to view the product in a manner similar to traditional online shopping interfaces.

In one or more embodiments, the images are often accompanied by descriptive text, specifications, and user reviews to provide additional context and information about the product. This conventional rendering method lacks the immersive and interactive elements of augmented reality, as the method does not integrate the item into the user's physical environment or personalize the visualization based on user-specific data. Instead, the method relies on pre-generated content that is uniformly presented to all users, regardless of individual preferences or needs.

Where decision 501 determines that an augmented reality device is in use with an interactive session of an electronic shopping interactive computing environment, decision 502 determines whether an item selected by user input in the electronic shopping interactive computing environment has a visible display capable of displaying a visible content item. Decision 502 of the method 500 in FIG. 5 can determine whether an item selected by user input in the electronic shopping interactive computing environment has a visible display capable of presenting a visible content item by employing multiple techniques.

One technique involves analyzing the metadata associated with the product listing, which often includes specifications about the product's features, such as the presence of a display and the display's capabilities. This method leverages existing data to quickly ascertain the display characteristics, ensuring efficient processing without requiring additional user input.

Another technique involves utilizing image recognition algorithms to analyze product images for the presence of a display. This approach is advantageous in scenarios where metadata is incomplete or unavailable, as it provides a visual confirmation of the display's existence and characteristics.

Additionally, the system can cross-reference the product with a database of known items, using model numbers or product identifiers to retrieve detailed specifications about the display capabilities. This cross-referencing technique ensures accuracy by relying on verified data sources, thereby enhancing the reliability of the determination process. Collectively, these techniques provide a robust framework for accurately identifying items with visible displays, facilitating the seamless integration of personalized content into the augmented reality environment.

If the item selected in the interactive session of the electronic shopping interactive computing environment fails to have a display, the method 500 returns to step 503 for conventionally rendering the images, albeit conventional rendering by an augmented reality device. Otherwise, the method 500 moves to step 504.

Step 504 of the method 500 in FIG. 5 involves determining the type of content that a device selected in an interactive session of an electronic shopping interactive computing environment, which includes a display, is capable of presenting. This determination can be achieved by analyzing the device's specifications and intended use.

For instance, when the selected device is a television, the system may identify that the television is suitable for displaying video content such as movies, television shows, or streaming media. Conversely, when the device is a digital photo frame, the system may determine that the digital photo frame is designed to present static images or slideshows.

Similarly, a gaming console would be identified as a device capable of rendering interactive video game content, while a smart speaker with a display might be recognized for its ability to show visual information related to audio content, such as song lyrics or album art. By leveraging metadata, product descriptions, and user preferences stored in a personal knowledge data store, the system can accurately ascertain the type of content each device is optimized to display, thereby enhancing the personalization and relevance of the augmented reality experience.

In step 505 of the method 500 depicted in FIG. 5, the system queries a personal knowledge data store to ascertain user preferences for the content type identified in step 504. This data store, which may reside locally on the user's device or be accessed remotely via a network, contains a comprehensive record of the user's past interactions, viewing habits, and content consumption patterns.

By analyzing this data, the system can determine the user's preferred genres, specific titles, or types of digital content that align with the user's interests. This process involves leveraging algorithms that can interpret the stored data to predict what the user would most likely want to see on the selected item during the interactive session. As a result, the system can tailor the augmented reality experience by selecting and displaying content that resonates with the user's personal tastes, thereby enhancing the overall engagement and satisfaction of the shopping experience.

Step 506 comprises retrieving, from a personal knowledge data store associated with the user, personalized visual content suitable for presentation by the item on the display in one or more embodiments. In other embodiments, step 506 comprises select a visual content offering that is personalized for a user directing the interactive shopping session using a personal knowledge data store associated with a user. In still other embodiments, step 506 comprises selecting, by the one or more processors, a personalized visual content offering capable of presentation on the visual display and identified as a preferred visual content offering by a personal knowledge data store associated with a user selecting the item.

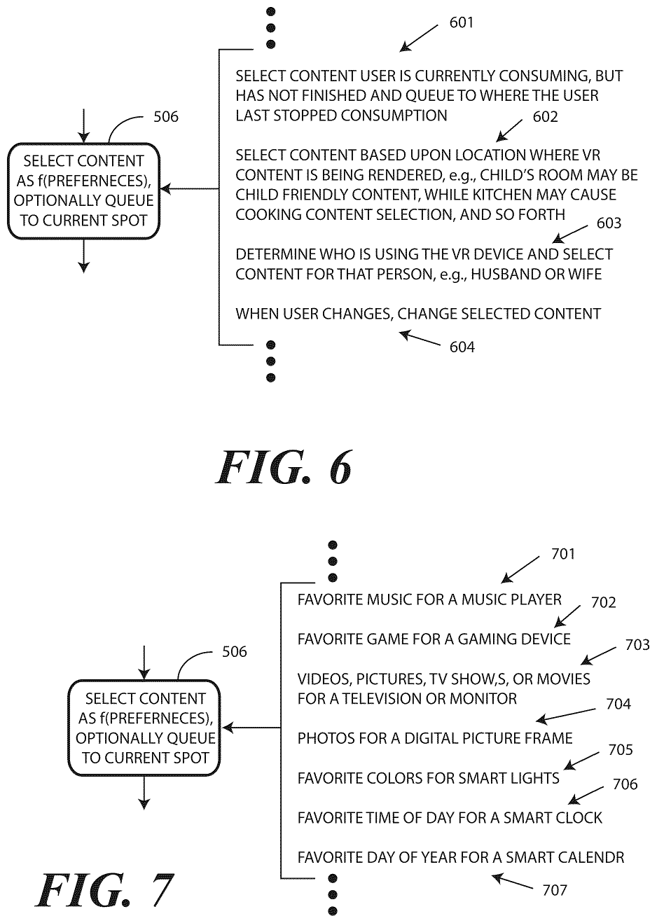

Step 506 can include other functionality as well. Illustrating by example, turning now to FIG. 6, illustrated therein are some of the ways that the method 500 of FIG. 5 can be modified at step 506. Others will be obvious to those of ordinary skill in the art having the benefit of this disclosure.

In one or more embodiments, step 506 can also optionally queue the content item selected to the point where the user last consumed the same. Said differently, in one or more embodiments, step 506 comprises determining, by the one or more processors, that the personalized visual content comprises partially consumed personalized visual content 601. This allows step 506 to generate a personalized item content by causing the display of the renderings of the item to present the personalized visual content starting where previous consumption of the partially consumed personalized visual content 601 ceased.

Embodiments of the disclosure contemplate that the content selected at step 506 can be selected as a function of a location 602 where the content will be rendered. In one or more embodiments, step 506 can comprise detecting, by the one or more processors from signals received by the communication device from the content renderer, a location where the content renderer will render the personalized item content. Where this occurs, step 506 can select the personalized visual content as a function of the location.

Embodiments of the disclosure contemplate that selecting the content to be presented on the display of the personalized item content as a function of the location where the content may be rendered offers significant benefits by enhancing the relevance and engagement of the user experience. For instance, when the personalized item content is rendered in a living room, the system might display family-oriented content, such as a popular family movie or a slideshow of family photos, to create a warm and inviting atmosphere.

Conversely, if the content is rendered in a home office, the display might show productivity-related content, such as a calendar, task list, or news updates, to support a focused work environment. Similarly, in a bedroom setting, the content could shift to more relaxing or personal media, such as a favorite TV series or soothing music videos, to promote relaxation and personal enjoyment. By tailoring the content to the specific location, the system not only enhances the user's interaction with the product but also aligns the digital experience with the user's contextual needs and preferences, thereby increasing satisfaction and the likelihood of product engagement

The person viewing the personalized content item can also affect the selection. Illustrating by example, embodiments of the disclosure contemplate that a husband and wife may both use the same smartphone to look at a television being rendered by augmented reality in the living room. The husband may prefer to watch pinball tutorials and Barry Harris jazz education videos. By contrast, the wife may prefer to watch Everybody Loves Raymond on a never ending, continuous loop. Accordingly, in one or more embodiments when signals indicate that the user changes, step 506 can select different content.

In embodiments of the present disclosure, selecting the content to be presented on the display of the personalized item content as a function of who 603 is using the electronic device to view the personalized item content at step 506 can significantly enhance user engagement and satisfaction. For instance, when a child is using the device, the system might display animated movies or educational content tailored to the child's interests, such as a favorite cartoon series or interactive learning modules.

Conversely, when an adult is using the device, the content could shift to more mature themes, such as a popular drama series, news updates, or a cooking show, reflecting the adult's preferences stored in their personal knowledge data store. Additionally, for a teenager, the system might present trending music videos, social media feeds, or gaming content that aligns with their current interests. By dynamically adapting the content based on the user's identity 603, the system not only personalizes the viewing experience but also ensures that the content is relevant and engaging for each individual, thereby increasing the likelihood of continued interaction and satisfaction with the product.

In one or more embodiments, step 506 comprises detecting, by the one or more processors from signals received by the communication device from the content renderer, a transfer of the content renderer 604 from the user to another user. In one or more embodiments, when this occurs, the method (500) of FIG. 5 can return to step (505) as shown in FIG. 5, with step 506 comprising again retrieving from another personal knowledge data store associated with the another user, other personalized visual content suitable for presentation by the item on the display. Step 506 can then comprise generating, by the one or more processors, other personalized item content by causing other digital renderings of the other personalized visual content to be presented on the display in other renderings of the item, with step 507 transmitting, by the one or more processors using a communication device, the other personalized item content to the content renderer.

Turning briefly to FIG. 7, illustrated therein are examples of various types of content that may be selected at step 506 for various types of devices. Others will be obvious to those of ordinary skill in the art having the benefit of this disclosure.

The content labeled 701 in FIG. 7 refers to the selection of favorite music for a music player. This content 701 plays a role in the personalized content delivery system, as the process involves identifying and selecting music tracks that align with the user's preferences stored in their personal knowledge base. The system can utilize algorithms to analyze the user's listening history, favorite genres, and frequently played tracks to curate a personalized playlist. This selection process enhances the user's experience by ensuring that the music player presents content that resonates with the user's tastes, thereby increasing engagement and satisfaction.

The content labeled 702 pertains to the selection of a favorite game for a gaming device. This allows a selection of the user's preferred gaming content based on their past interactions, such as the games they play most frequently or genres they favor. The system can access the user's gaming history and preferences stored in the personal knowledge base to select a game that the user is likely to enjoy. This personalized approach not only enhances the gaming experience by providing content that aligns with the user's interests but also encourages continued use of the gaming device.

The content labeled 703 involves the selection of videos, pictures, TV shows, or movies for a television or monitor. This content plays a role in delivering a personalized viewing experience, as it involves curating visual content that matches the user's preferences. The system can analyze the user's viewing habits, favorite genres, and most-watched content to select videos or shows that the user is likely to find appealing. By presenting personalized content on the television or monitor, the system enhances the user's engagement and satisfaction with the device.

The content labeled 704 refers to the selection of photos for a digital picture frame. This involves curating a collection of images that hold personal significance to the user, such as family photos, memorable events, or favorite landscapes. The system can access the user's photo library and preferences stored in the personal knowledge base to select images that the user is likely to appreciate. By displaying personalized photos, the digital picture frame becomes a more meaningful and engaging device for the user.

The content labeled 705 involves the selection of favorite colors for smart lights. This component plays a role in creating a personalized lighting experience, as it involves adjusting the color settings of smart lights to match the user's preferences. The system can analyze the user's past interactions with smart lights, such as their preferred color schemes or lighting moods, to select colors that the user is likely to enjoy. By providing personalized lighting, the system enhances the user's satisfaction and engagement with the smart lighting system.

The content labeled 706 pertains to the selection of a favorite time of day for a smart clock. This involves configuring the smart clock to display information or perform actions that align with the user's preferred time of day. The system can access the user's schedule, routines, and preferences stored in the personal knowledge base to determine the optimal time for displaying certain information or triggering specific actions. By tailoring the smart clock's functionality to the user's preferences, the system enhances the user's experience and satisfaction with the device.

The content labeled 707 involves the selection of a favorite day of the year for a smart calendar. This component plays a significant role in personalizing the user's interaction with the smart calendar, as it involves highlighting or celebrating days that hold particular significance to the user, such as birthdays, anniversaries, or holidays. The system can access the user's calendar entries and preferences stored in the personal knowledge base to identify and emphasize these important dates. By providing personalized calendar features, the system enhances the user's engagement and satisfaction with the smart calendar.

Turning now back to FIG. 5, in one or more embodiments, step 506 also comprises creating, by one or more processors, an augmented reality rendering of the item delivering the preferred visual content offering to an environment. Step 507 then comprises transmitting, by the one or more processors using a communication device, the augmented reality rendering to the augmented reality device. Step 508 then renders the content to the environment.

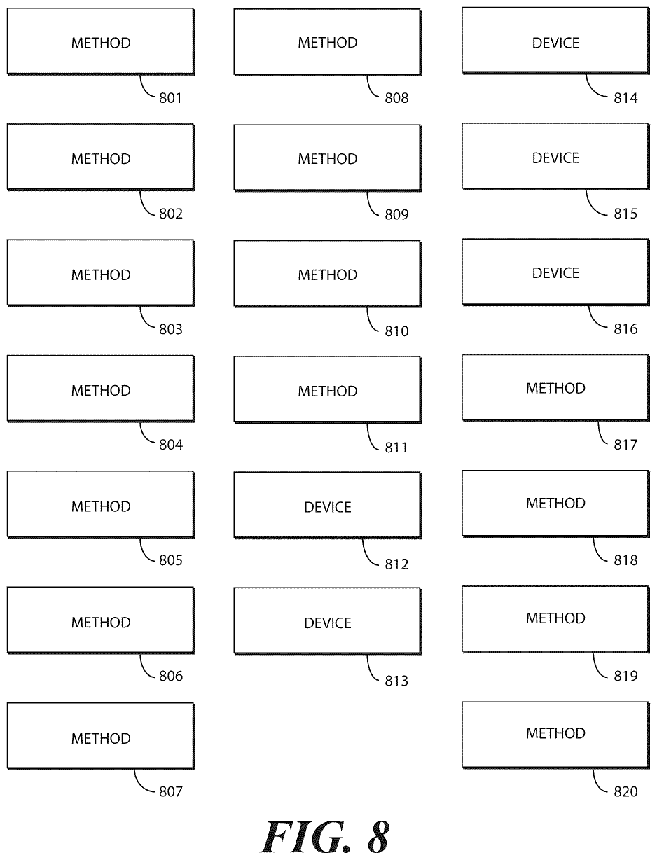

Turning now to FIG. 8, illustrated therein are various embodiments of the disclosure. The embodiments of FIG. 8 are shown as labeled boxes in FIG. 8 due to the fact that the individual components of these embodiments have been illustrated in detail in FIGS. 1-7, which precede FIG. 8. Accordingly, since these items have previously been illustrated and described, their repeated illustration is no longer essential for a proper understanding of these embodiments. Thus, the embodiments are shown as labeled boxes.

At 801, a method in an electronic device comprises, in response to initiation of an interactive session in an electronic shopping interactive computing environment operating on one or more processors of the electronic device, detecting, by a user interface operable with the one or more processors, user input from a user selecting an item having a display to be rendered to the user by a content renderer. At 801, the method comprises retrieving, from a personal knowledge data store associated with the user, personalized visual content suitable for presentation by the item on the display.

At 801, the method comprises generating, by the one or more processors, personalized item content for the content renderer by causing digital renderings of the personalized visual content to be presented on the display in renderings of the item. At 801, the method comprises transmitting, by the one or more processors using a communication device, the personalized item content to the content renderer.

At 802, the method of 801 further comprises detecting, by the one or more processors from signals received by the communication device from the content renderer, a location where the content renderer will render the personalized item content. At 802, the method comprises modifying, by the one or more processors, the personalized item content to correspond to the location.

At 803, the retrieving of 801 from the personal knowledge data store associated with the user the personalized visual content comprises performing a web-scraping technique to identify content offerings previously consumed by the user. At 804, the personalized visual content of 803 comprises a most-consumed visual content offering associated with the user.

At 805, the item of 801 comprises a television. At 806, the personalized visual content of 805 comprises one of a video, a television show, or a movie. At 807, the content renderer of 801 comprises an augmented reality optical projection device.

At 808, the method of 801 further comprises determining, by the one or more processors, that the personalized visual content comprises partially consumed personalized visual content. At 808, the generating the personalized item content comprises causing the display of the renderings of the item to present the personalized visual content starting where previous consumption of the partially consumed personalized visual content ceased.

At 809, the method of 801 further comprises detecting, by the one or more processors from signals received by the communication device from the content renderer, a location where the content renderer will render the personalized item content. At 809, the personalized visual content is selected as a function of the location.

At 810, the method of 801 further comprises detecting, by the one or more processors from signals received by the communication device from the content renderer, a transfer of the content renderer from the user to another user. At 810, the method comprises again retrieving from another personal knowledge data store associated with the another user, other personalized visual content suitable for presentation by the item on the display.

At 810, the method comprises generating, by the one or more processors, other personalized item content by causing other digital renderings of the other personalized visual content to be presented on the display in other renderings of the item. At 810, the method comprises transmitting, by the one or more processors using a communication device, the other personalized item content to the content renderer. At 811, the generating of 801 occurs only when the content renderer comprises an augmented reality optical projection device.

At 812, an electronic device comprises a communication device. At 812, the electronic device comprises one or more processors operable with the communication device.

At 812, the one or more processors are configured to generate personalized item content for an augmented reality optical projection device in response to the one or more processors detecting commencement of an interactive shopping session in an electronic shopping interactive computing environment. At 812, the one or more processors are configured to detect selection of a product capable of presenting visual content on a display of the product during the interactive shopping session.

At 812, the one or more processors are configured to select a visual content offering that is personalized for a user directing the interactive shopping session using a personal knowledge data store associated with a user. At 812, the one or more processors are configured to generate the personalized item content by integrating renderings of the visual content offering with other renderings of the product. At 812, the one or more processors are configured to transmit, using the communication device, the personalized content item to the augmented reality optical projection device.

At 813, the one or more processors of 812 access the personalized knowledge data store from a remote electronic device across a network using the communication device. At 814, the remote electronic device of 813 is a companion electronic device of, and operable with, the augmented reality optical projection device.

At 815, the visual content offering of 812 is identified as a favorite movie, video, or television show in the personal knowledge data store. At 816, the visual content offering of 812 is a partially consumed visual content offering. At 816, the one or more processors generate the personalized item content by integrating renderings of unconsumed portions of the visual content offering with the other renderings of the product.

At 817, a method in an electronic device comprises detecting, by one or more processors, an interactive session of an electronic shopping interactive computing environment selecting an item with a visual display to be rendered by an augmented reality device. At 817, the method comprises selecting, by the one or more processors, a personalized visual content offering capable of presentation on the visual display and identified as a preferred visual content offering by a personal knowledge data store associated with a user selecting the item.

At 817, the method comprises creating, by the one or more processors, an augmented reality rendering of the item delivering the preferred visual content offering to an environment. At 817, the method comprises transmitting, by the one or more processors using a communication device, the augmented reality rendering to the augmented reality device.

At 818, the preferred visual content offering of 817 comprises images or video. At 819, the selecting the personalized visual content offering of 817 is performed using an artificial intelligence process. At 820, the method of claim 17, wherein the augmented reality device comprises augmented reality glasses.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims.

For example, in one embodiment the electronic device is configured to operate with an augmented reality optical projection device that is integrated into a pair of augmented reality glasses. These glasses allow the user to visualize the personalized item content directly in their field of view, enhancing the immersive shopping experience.

In another embodiment, the electronic device is a smartphone or tablet that communicates with a standalone augmented reality headset, which projects the personalized item content onto a virtual display within the headset. This setup allows users to interact with the content in a fully immersive virtual environment.

Additionally, the electronic device may be configured to access the personal knowledge data store either locally, where the data is stored on the device itself, or remotely, where the data is accessed from a cloud-based server. This flexibility in data access allows for seamless integration with various user data management systems.

Furthermore, the visual content offering can be dynamically updated based on real-time user interactions, such as changes in user preferences or recent content consumption, ensuring that the personalized item content remains relevant and engaging. The system may also include adaptive algorithms that adjust the rendering quality and content selection based on the device's processing capabilities and network conditions, providing an optimized user experience across different hardware configurations.

Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims.

What is claimed is:

1. A method in an electronic device, the method comprising:
in response to initiation of an interactive session in an electronic shopping interactive computing environment operating on one or more processors of the electronic device, detecting, by a user interface operable with the one or more processors, user input from a user selecting an item having a display to be rendered to the user by a content renderer;
retrieving, from a personal knowledge data store associated with the user, personalized visual content suitable for presentation by the item on the display;
generating, by the one or more processors, personalized item content for the content renderer by causing digital renderings of the personalized visual content to be presented on the display in renderings of the item; and
transmitting, by the one or more processors using a communication device, the personalized item content to the content renderer.

2. The method of claim 1, further comprising:
detecting, by the one or more processors from signals received by the communication device from the content renderer, a location where the content renderer will render the personalized item content; and
modifying, by the one or more processors, the personalized item content to correspond to the location.

3. The method of claim 1, wherein the retrieving from the personal knowledge data store associated with the user the personalized visual content comprises performing a web-scraping technique to identify content offerings previously consumed by the user.

4. The method of claim 3, wherein the personalized visual content comprises a most-consumed visual content offering associated with the user.

5. The method of claim 1, wherein the item comprises a television.

6. The method of claim 5, wherein the personalized visual content comprises one of a video, a television show, or a movie.

7. The method of claim 1, wherein the content renderer comprises an augmented reality optical projection device.

8. The method of claim 1, further comprising determining, by the one or more processors, that the personalized visual content comprises partially consumed personalized visual content, wherein the generating the personalized item content comprises causing the display of the renderings of the item to present the personalized visual content starting where previous consumption of the partially consumed personalized visual content ceased.

9. The method of claim 1, further comprising detecting, by the one or more processors from signals received by the communication device from the content renderer, a location where the content renderer will render the personalized item content, wherein the personalized visual content is selected as a function of the location.

10. The method of claim 1, further comprising:
detecting, by the one or more processors from signals received by the communication device from the content renderer, a transfer of the content renderer from the user to another user;
again retrieving from another personal knowledge data store associated with the another user, other personalized visual content suitable for presentation by the item on the display;
generating, by the one or more processors, other personalized item content by causing other digital renderings of the other personalized visual content to be presented on the display in other renderings of the item; and
transmitting, by the one or more processors using a communication device, the other personalized item content to the content renderer.

11. The method of claim 1, wherein the generating occurs only when the content renderer comprises an augmented reality optical projection device.

12. An electronic device, comprising:
a communication device;
one or more processors operable with the communication device and configured to generate personalized item content for an augmented reality optical projection device in response to the one or more processors detecting commencement of an interactive shopping session in an electronic shopping interactive computing environment by being configured to:
detect selection of a product capable of presenting visual content on a display of the product during the interactive shopping session;
select a visual content offering that is personalized for a user directing the interactive shopping session using a personal knowledge data store associated with a user;
generate the personalized item content by integrating renderings of the visual content offering with other renderings of the product; and
transmit, using the communication device, the personalized content item to the augmented reality optical projection device.

13. The electronic device of claim 12, wherein the one or more processors access the personalized knowledge data store from a remote electronic device across a network using the communication device.

14. The electronic device of claim 13, wherein the remote electronic device is a companion electronic device of, and operable with, the augmented reality optical projection device.

15. The electronic device of claim 12, wherein the visual content offering is identified as a favorite movie, video, or television show in the personal knowledge data store.

16. The electronic device of claim 12, wherein when the visual content offering is a partially consumed visual content offering, the one or more processors generate the personalized item content by integrating renderings of unconsumed portions of the visual content offering with the other renderings of the product.

17. A method in an electronic device, the method comprising:
detecting, by one or more processors, an interactive session of an electronic shopping interactive computing environment selecting an item with a visual display to be rendered by an augmented reality device;
selecting, by the one or more processors, a personalized visual content offering capable of presentation on the visual display and identified as a preferred visual content offering by a personal knowledge data store associated with a user selecting the item;
creating, by the one or more processors, an augmented reality rendering of the item delivering the preferred visual content offering to an environment; and
transmitting, by the one or more processors using a communication device, the augmented reality rendering to the augmented reality device.

18. The method of claim 17, wherein the preferred visual content offering comprises images or video.

19. The method of claim 17, wherein the selecting the personalized visual content offering is performed using an artificial intelligence process.

20. The method of claim 17, wherein the augmented reality device comprises augmented reality glasses.
